(19) United States
(12) Patent Application Publication
(10) Pub. No.: US 2007/0026346 A1
(43) Pub. Date: Feb. 1, 2007

(54) Cleaning solution for lithography

(76) Inventor: Kazuhiko Nakayama, Kawasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/489,492

(22) Filed: Jul. 20, 2006

(30) Foreign Application Priority Data
Jul. 28, 2005 (JP) 2005-219372

(51) Int. Cl. G03C 5/00

(52) U.S. Cl. 430/331

(57) ABSTRACT

Provided is a cleaning solution for lithography comprising (A) from 5 to 100% by mass of a lower alkyl ketone and (B) from 95 to 0% by mass of γ-butyrolactone which is a cleaning solution capable of exhibiting universally good cleaning power to a photoresist of an ArF formulation, for which no sufficient cleaning can be conducted with conventional cleaning solutions, with good drying behavior after treatment still without adversely affecting the properties of the photoresist by cleaning.

### BACKGROUND OF THE INVENTION

The present invention relates to a cleaning solution which can be used in the manufacture of resist patterns utilizing the lithographic technology or, more particularly, to a cleaning solution for lithography used for dissolving away and to remove the photoresist composition deposited on extraneous areas of substrate or the photoresist remaining in the photoresist feeder unit.

The substrate materials used for the manufacture of semiconductor devices and liquid crystal display panels typically include semiconductor silicon wafers and glass plates, which are coated with a photoresist composition to form a photoresist layer to be patterned by the well-established lithographic patterning technology. In the above-mentioned step of coating of the substrate with the photoresist composition, it is almost always unavoidable that the resist composition is more or less deposited onto the areas of the substrate other than the areas for patterning such as the marginal areas around the patterning areas and the substrate surface reverse to the patterning surface. In addition, the apparatuses and machines used for the coating step are necessarily contaminated with the photoresist composition. It is highly desirable that such extraneous depositions of the photoresist composition are removed by dissolving away with a cleaning solution.

In order for the removing treatment of the extraneous resist composition to be conducted with a good efficiency, the cleaning solution must satisfy various requirements including, for example, rapid dissolving of the resist composition and rapid drying after dissolving away of the resist composition as well as the inertness to the properties of the photoresist layer by cleaning.

Needless to say, a large variety of photoresist compositions are currently on use depending, for example, on the types of the exposure rays for patterning including g-line and i-line UV lights, KrF and ArF excimer laser beams and others. Each of the photoresist compositions is suitable for patterning with a particular type of the exposure rays so that no single cleaning solution can be used universally for multiplicity of photoresist compositions leading to proposals for a variety of cleaning solutions.

For example, the cleaning solutions heretofore proposed and actually employed include those solutions based on ethyleneglycol or esters thereof (see JP5-75110B), the solutions based on a propyleneglycol alkyl ether acetate (see JP4-49938B), the solutions based on an alkyl 3-alkoxypropionate (see JP4-42523A), the solutions based on alkyl pyruvate (see JP4-130715A) and others.

Mixtures of two kinds or more of organic solvents are also proposed as the cleaning solution including, for example, a solvent mixture consisting of a propyleneglycol alkyl ether, a monoketone compound having 1 to 7 carbon atoms per molecule and a lactam or lactone compound (see JP11-218933A), mixtures of n kinds of solvents defined in terms of the solubility parameter δ which satisfies the relationship of 9≦Σxᵢδᵢ≦12 assuming that the weight proportion of the i-th component is xᵢ and the solubility parameter thereof is δᵢ as calculated by the Fedors method (see JP2003-114538A) and others.

These prior art cleaning solutions, however, have limited applicability to exhibit good removing performance with a few particular photoresist compositions only and no effective cleaning solutions are known heretofore useful with the resist compositions for ArF excimer laser beams exposure expected as the major current of the lithographic patterning technology.

With respect to the apparatuses coming into contact with the photoresist composition during the patterning works, on the other hand, these apparatuses involve various parts liable to deposition of and contamination with the resist composition such as bellows pumps and filter elements, piping junctions and deadspaces. Accordingly, proposals are made for cleaning solutions with which fine particulates deposited on the above parts can be washed away. Examples of such cleaning solutions include those solutions based on γ-butyrolactone for the apparatuses working with the photoresist compositions prepared by dissolving an alkali-soluble resin and a quinonediazide-based photosensitive compound in an organic solvent (see JP6-346091A).

With regard to such a cleaning solution, it is desired that a cleaning solution can be used universally for the same purpose of use including, in particular, cleaning of the inside of cups, cleaning of edge areas of substrates, cleaning of reverse surface of substrates, cleaning of pipelines, rework cleaning, prewetting and so on due to the limited number of the pipelines of the cleaning solutions for lithography.

Since it is difficult to dissolve the resist for ArF excimer laser with an acrylic polymer as a component by using the heretofore known cleaning solutions for lithography, however, it is impossible to satisfactorily conduct cleaning on the peripheral areas and reverse surface of substrates and no satisfactory results can be obtained in cleaning and removing the unnecessary portions of the resist or residues of the resist for ArF excimer laser lithography from the parts of the resist feeder unit (coater cups and pipelines) having adherence of the resist residue by using a conventional cleaning solution.

### SUMMARY OF THE INVENTION

The present invention has been completed with an object to provide a cleaning solution which exhibits a good cleaning power to an ArF-adaptable resist of which no sufficient cleaning could be performed heretofore, in particular, with known cleaning solutions, having good dryability after treatment still without damaging the characteristics of the resist by cleaning.

The inventors have continued extensive investigations in order to develop a cleaning solution which can be used satisfactorily in the manufacture of resist patterns utilizing the lithographic technology and still effective for the residue of an ArF resist which cannot be removed with conventional cleaning solutions arriving at a result of discovery that a lower-alkyl ketone alone or a mixture thereof with a γ-butyrolactone exhibits a dissolving power of about 2 to 50 times high for the residues of an ArF resist as compared with conventional cleaning solutions leading to completion of the present invention on the base of this discovery.

Thus, the present invention provides a cleaning solution for lithography which comprises (A) from 5 to 100% by mass of a lower-alkyl ketone and (B) from 95 to 0% by mass of γ-butyrolactone. The lower-alkyl ketone herein means a ketone having an alkyl group of 3 or less carbon atoms.

### DETAILED DESCRIPTION OF THE PREFERRED EMBODIMENTS

The cleaning solution of the present invention either can be the component (A), i.e. a lower-alkyl ketone, alone or can be a mixture of this component (A) with the component (B), i.e. γ-butyrolactone. In the latter case, the mixing proportion should be selected within the range of 5% by mass or larger of the component (A) and 95% by mass or smaller of the component (B) or, preferably, 30-95% by mass of the component (A) and 70-5% by mass of the component (B).

The lower-alkyl ketone as the component (A) is exemplified by those ketones having an alkyl group with 3 or less of carbon atoms such as methyl ethyl ketone, methyl isopropyl ketone, diethyl ketone, ethyl propyl ketone and the like of which methyl ethyl ketone is particularly preferred because of the good dissolving power to acrylic polymers.

γ-Butyrolactone as the component (B) is used by virtue of the enhanced safety due to the elevation of the ignition point caused by the admixture with the same. While the lower-alkyl ketones used alone have a low ignition point accompanied by dangers in working, the dangers in working can be decreased due to the elevation in the ignition point when used as a mixed solvent. Besides, the width of adaptability to the ArF resists can be increased by the admixture with γ-butyrolactone. While a great variety of resinous ingredients are employed for the ArF resists, namely, excellent dissolving power can be exhibited to any one of them.

Removal of the resist film formed on the substrate from the unnecessitating areas, i.e., from the peripheral edge areas and reversed surface areas by using the cleaning solution of the present invention can be performed in the same way as in the case where a known cleaning solution is employed. Namely, for example, the cleaning solution is ejected from a nozzle disposed at a distance of 3-10 mm or, preferably, 4-6 mm from the periphery of the substrate after formation of a resist film by coating of the substrate with a desired resist followed by drying at a rate of 5-20 ml/minute or, preferably, 7-15 ml/minute for 5-60 seconds or, preferably, for 10-30 seconds to clean up the peripheral areas of the resist film followed by drying by being kept standing. In this way, it is possible to completely remove the unnecessary portions alone from the peripheral areas almost without damages on the resist film surfaces other than the peripheral areas.

When the residues of the resist within the resist feeder unit is to be removed, the cleaning solution should simply be brought into contact therewith while this contacting method can be performed either by the ejection of the cleaning solution as mentioned above or by contacting with a liquid stream. Alternatively, the part with deposition of the photoresist residue can be dipped in the cleaning solution under swaying to cause washing away. The contacting time in this case between the apparatus and the cleaning solution should be from 1-10 minutes or, preferably, from 1 and a half minutes to 5 minutes.

Observations by using a stepped level detector or a scanning electron microscope can be applied to checking of complete removal of any unnecessary resist composition from the peripheral areas, reverse surface and so on of the substrate. It is possible by visual inspection to confirm removal of the resist residues from inside of the resist feeder unit.

According to the present invention, it is now possible to dissolve and remove the photoresist or, in particular, the photoresist containing an acrylic polymer for use with an ArF excimer laser in the extraneous portions of the resist on a substrate and the resist remaining in the pipelines of a resist feeder unit and coater cups as well as connection joints and elsewhere with an about 2 to 50 times higher dissolving rate as compared with heretofore known solvents.

Accordingly, the cleaning solution of the present invention can be utilized in a variety of ways for removing the photoresist in extraneous portions such as the peripheral portions and reverse side surfaces occurring in the coating of substrates with a photoresist so as to contribute to prevention of occurrence of defects in the products caused by the presence of unnecessary portions, cleaning of pipelines, rework cleaning, prewetting and so on.

In the following, Examples are given to illustrate the best modes for practicing the present invention although the scope of the present invention is never limited thereby.

### EXAMPLE 1 AND COMPARATIVE EXAMPLES 1 TO 7.

A dried resinous solid sample of an ArF photoresist composition was prepared by subjecting a commercial photoresist TArF-P6111 (product name by Tokyo Ohka Kogyo Co.) containing an acrylic resin as a principal ingredient to evaporation of the solvent to dryness under reduced pressure on a water bath at 90° C. A 100 mg portion of the thus obtained solid sample in the form of flakes was taken in a test tube together with 100 ml of one of eight solvents indicated below and gently shaken at 25° C. until complete disappearance of the solid by dissolution to record the time length therefor. The results are shown in Table 1 below in which the names of the solvents are given with two-to four-letter abbreviation.
Solvents used
MEK: methyl ethyl ketone
GBL: γ-butyrolactone
PM: propyleneglycol monomethyl ether acetate
PE: propyleneglycol monomethyl ether
EL: ethyl lactate
CH: cyclohexanone
MAK: methyl amyl ketone

MIBK: methyl isobutyl ketone

TABLE 1

| | Example | | | | | | | |
|---|---|---|---|---|---|---|---|---|
| | | Comparative Example | | | | | | |
| | Example 1 | 1 | 2 | 3 | 4 | 5 | 6 | 7 |
| Cleaning | MEK | GBL | PM | PE | EL | CH | MAK | MIBK |
| solution | | | | | | | | |
| Time | 1 min. 50 s | 15 min. | 55 min. | 45 min. | 60 min. | 45 min. | 40 min. | 45 min. |

As is understood from the results shown in Table 1, methyl ethyl ketone has an outstandingly high dissolving power to an acrylic resin-containing photoresist composition as compared with the other organic solvents.

### Example 2

Eleven mixed solvents were prepared by mixing methyl ethyl ketone (MEK) and γ-butyrolactone (GBL) in specified mass proportions and each of them was employed in the dissolving test of a solid resist resin in the same manner as in Example 1. Table 2 below shows the mixing proportion of the two solvents and the time taken for complete disappearance of the solid resin by dissolution in the solvent.

TABLE 2

| | GBL:MEK (mass proportion) | | | | | | | | | | |
|---|---|---|---|---|---|---|---|---|---|---|---|
| | 95:5 | 90:10 | 80:20 | 70:30 | 60:40 | 50:50 | 40:60 | 30:70 | 20:80 | 10:90 | 5:95 |
| Time, | 345 | 300 | 240 | 130 | 115 | 110 | 110 | 110 | 110 | 110 | 107 |
| seconds | | | | | | | | | | | |

As is understood from Table 2, the dissolving power of the mixed solvents as a cleaning solution for solid resist resin is high enough as compared with the solvents used in Comparative Examples 1 to 7 when the mixing mass proportion of methyl ethyl ketone is 5% by mass or higher. The dissolving power is especially high when the mixing proportion of methyl ethyl ketone is 30% by mass or higher.

### Example 3

A test sample was prepared by spin-coating on a 200 mm diameter semiconductor silicon wafer with an ArF photoresist composition TArF-P6111, supra, on a spin coater (Model DNS D-SPIN, manufactured by Dai-Nippon Screen Mfg. Co.) rotating at 2500 rpm for 10 seconds to form a resist film of 1.35 μm thickness followed by drying by heating at 60° C. for 80 seconds.

In the next place, the same cleaning solution as used in Example 1 or, namely, methyl ethyl ketone was ejected onto the resist-coated silicon wafer at 25° C. for 60 seconds at a rate of 10 ml/minute through a nozzle directed to a point on the wafer 5 mm apart from the periphery of the wafer to remove the peripheral portion of the resist film followed by air-drying taking 30 seconds.

The peripheral areas of the resist film after the above described treatment were subjected to scanning with a probe-type surface contour detector Model DEKTAK8, manufactured by Ulvac, Inc., to detect an enlarged profile form in the cross sectional direction. The results were that removal of the unnecessary portion of the resist film on the peripheral areas was almost complete substantially without affecting the surface of the resist film excepting the peripheral areas.

### Example 4

The same treatment as in Example 3 was undertaken by using a 50:50 by mass mixture of methyl ethyl ketone and γ-butyrolactone as the cleaning solution instead of the cleaning solution used in Example 1. Thereafter, detection of the surface contour of the resist film on the peripheral areas was conducted in the same manner as in Example 3 to find that removal of the unnecessary peripheral portions of the resist film was almost complete substantially without any adverse influences on other areas.

### COMPARATIVE EXAMPLE 8

By using the cleaning solution as used in Comparative Example 1 or, namely, γ-butyrolactone, instead of the cleaning solution used in Example 1, the same sample as used in Example 3 was subjected to the same treatment as in Example 3 and detection of the surface contour of the resist film was conducted on the peripheral areas in the same manner with almost no removal of the resist film on the peripheral areas.

What is claimed is:

1. A cleaning solution for lithography comprising (A) from 5 to 100% by mass of a lower alkyl ketone and (B) from 95 to 0% by mass of γ-butyrolactone.

2. The cleaning solution for lithography according to claim 1 comprising from 30 to 95% by mass of the component (A) and from 70 to 5% by mass of the component (B).

3. The cleaning solution for lithography according to claim 1 wherein the lower alkyl ketone is methyl ethyl ketone.

4. The cleaning solution for lithography according to claim 1 which is for use in removing a photoresist composition containing an acrylic polymer.

5. The cleaning solution for lithography according to claim 1 which is for removing a residual matter of a photoresist composition containing an acrylic polymer deposited onto a photoresist feeder unit.
